(19) United States
(12) Patent Application Publication
(10) Pub. No.: US 2023/0422125 A1
(43) Pub. Date: Dec. 28, 2023

(54) METHOD AND APPARATUS FOR MEASUREMENTS FOR UE MOBILITY BETWEEN NTN AND TN

(71) Applicant: Samsung Electronics Co., Ltd., Suwon-si (KR)

(72) Inventors: Kyeongin Jeong, Allen, TX (US); Shiyang Leng, Allen, TX (US)

(21) Appl. No.: 18/336,812

(22) Filed: Jun. 16, 2023

Related U.S. Application Data
(60) Provisional application No. 63/356,380, filed on Jun. 28, 2022.

(51) Int. Cl. H04W 36/08; H04W 36/32; H04W 36/00

(52) U.S. Cl. CPC H04W 36/083; H04W 36/322; H04W 36/0085

(57) ABSTRACT

Methods and apparatuses for measurements for UE mobility between an NTN and a TN. A method of operating a UE comprises: identifying terrestrial network (TN) neighboring cell information received from a non-terrestrial network (NTN), wherein the TN neighboring cell information includes at least TN neighboring cell geographical area; identifying a location of the UE; determining, based on the location of the UE and the TN neighboring cell information, whether to measure TN neighboring cells; identifying, based on a determination that TN neighboring cells are measured, one or more TN neighboring cells among the TN neighboring cells; and measuring the one or more TN neighboring cells for a cell reselection operation.

### CROSS-REFERENCE TO RELATED APPLICATIONS AND CLAIM OF PRIORITY

The present application claims priority to U.S. Provisional Patent Application No. 63/356,380, filed on Jun. 28, 2022. The content of the above-identified patent document is incorporated herein by reference.

### TECHNICAL FIELD

The present disclosure relates generally to wireless communication systems and, more specifically, the present disclosure relates to measurements for UE mobility between a non-terrestrial network (NTN) and terrestrial network (TN).

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to measurements for UE mobility between an NTN and a TN.

In one embodiment, a user equipment (UE) is provided. The UE comprises a transceiver and a processor operably coupled to the transceiver. The processor of UE is configured to: identify TN neighboring cell information received from an NTN, wherein the TN neighboring cell information includes at least TN neighboring cell geographical area; identify a location of the UE; determine, based on the location of the UE and the TN neighboring cell information, whether to measure TN neighboring cells; identify, based on a determination that TN neighboring cells are to be measured, one or more TN neighboring cells among the TN neighboring cells; and measure the one or more TN neighboring cells for a cell reselection operation.

In another embodiment, a method of a UE is provided. The method comprises: identifying TN neighboring cell information received from am NTN, wherein the TN neighboring cell information includes at least TN neighboring cell geographical area; identifying a location of the UE; determining, based on the location of the UE and the TN neighboring cell information, whether to measure TN neighboring cells; identifying, based on a determination that TN neighboring cells are to be measured, one or more TN neighboring cells among the TN neighboring cells; and measuring the one or more TN neighboring cells for a cell reselection operation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of NTN communication according to embodiments of the present disclosure;

FIGS. 7A and 7B illustrate examples of bear-far effect according to embodiments of the present disclosure;

FIG. 8 illustrates signaling flows between a UE and NTN according to embodiments of the present disclosure;

FIG. 9 illustrates a flowchart of UE method according to embodiments of the present disclosure; and

FIG. 10 illustrates a flowchart of UE method for the mobility support between NTN and TN according to embodiments of the present disclosure.

### DETAILED DESCRIPTION

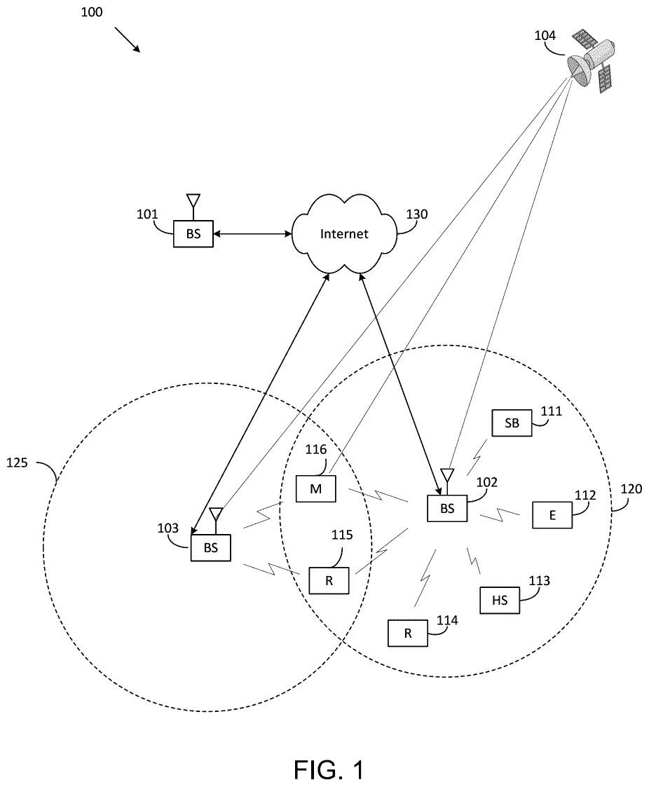

FIG. 1 through FIG. 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein:

3GPP TR 38.821 v.16.0.0: “Solutions for NR to support non-terrestrial networks (NTN)”; 3GPP TS 38.321 v.17.2.0: “NR; Medium Access Control (MAC) protocol specification”; 3GPP TS 38.331 v.17.2.0: “NR; Radio Resource Control (RRC) protocol specification”; 3GPP TS 38.304 v.17.2.0: “NR; User Equipment (UE) procedures in Idle mode and RRC inactive state”; 3GPP TS 38.101-1 v.17.7.0: “NR; User Equipment (UE) radio transmission and reception; Part 1: Range 1 Standalone”; 3GPP TS 38.101-2 v.16.4.0: “NR; User Equipment (UE) radio transmission and reception; Part 2: Range 2 Standalone”; and 3GPP TS 37.355 v.17.2.0: “LTE Positioning Protocol (LPP).”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in obit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. Various of the UEs (e.g., as depicted by UE 116) may be capable of at least some direct communication and/or localization with the communication satellite(s) 104, for example, to receive positional information or coordinates.

An NTN refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof, for measurements for UE mobility between an NTN and a TN. In certain embodiments, and one or more of the gNBs 101-103 includes circuitry, programing, or a combination thereof, for supporting measurements for UE mobility between an NTN and a TN.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

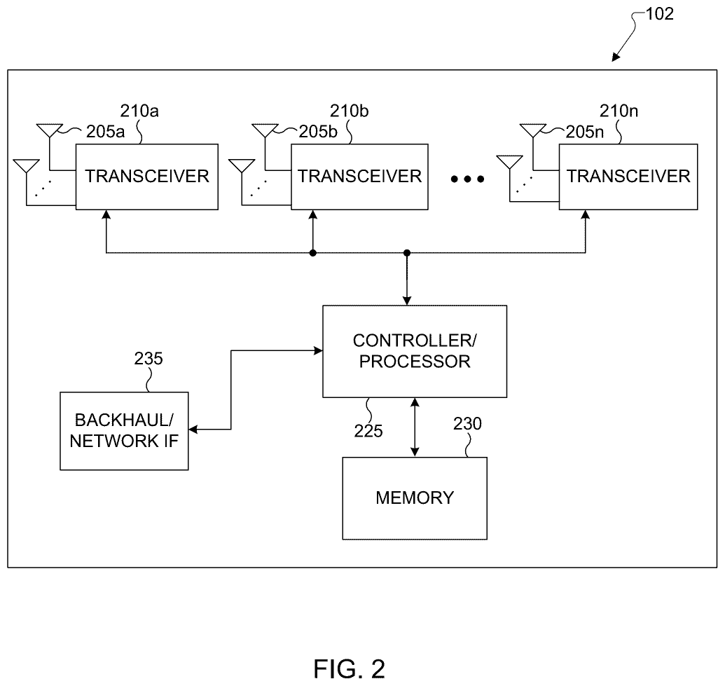

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes for supporting measurements for UE mobility between an NTN and a TN in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

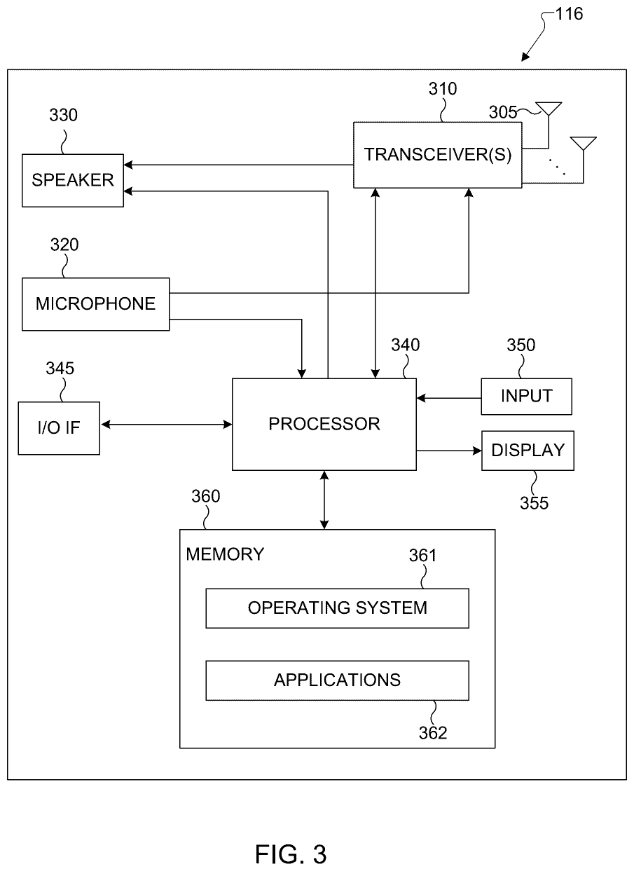

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for measurements for UE mobility between an NTN and a TN in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/0 interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

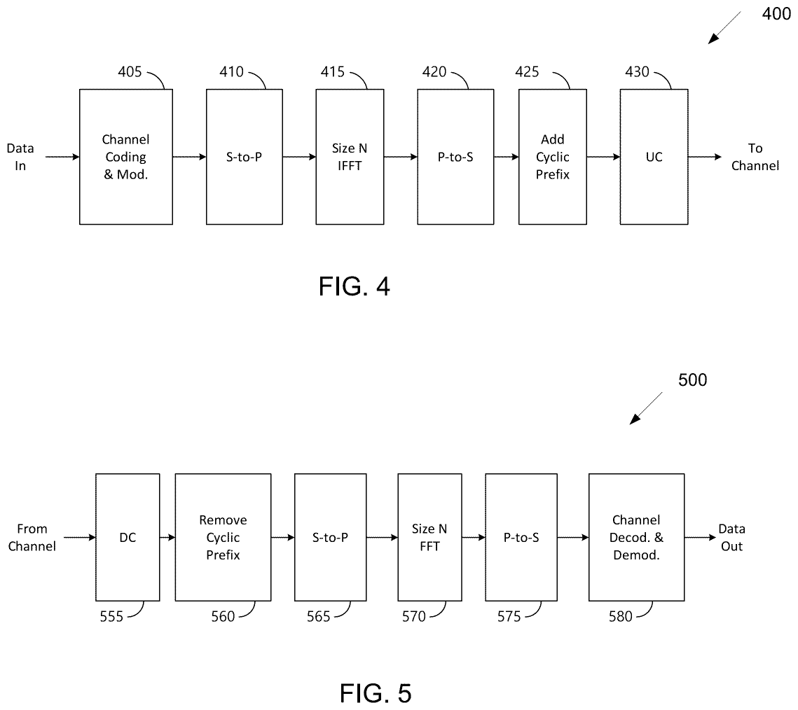

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support measurements for UE mobility between an NTN and a TN in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNB s 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

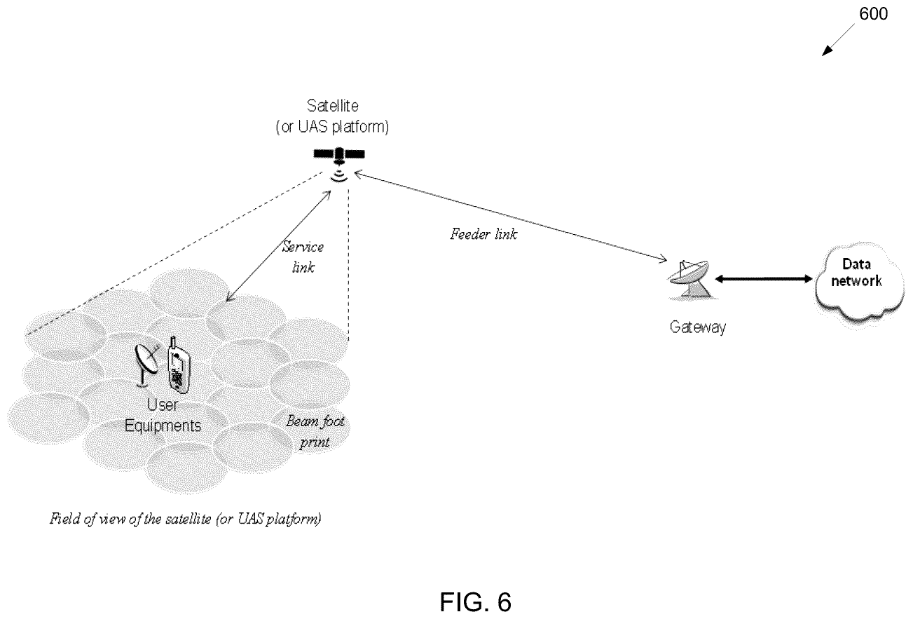

FIG. 6 illustrates an example of NTN communication 600 according to embodiments of the present disclosure. An embodiment of the NTN communication 600 shown in FIG. 6 is for illustration only.

In 3GPP wireless standards, new radio access technology (NR) is discussed as 5G wireless communication technology. One of NR feature under the discussion is an NTN. An NTN refers to a network, or segment of networks using RF resources on board a satellite (or unmanned aircraft system (UAS) platform) as shown FIG. 6. An NTN typically features the following example elements.

In one example, one or several sat-gateways may connect the NTN to a public data network.

In one example, a geostationary earth orbit (GEO), circular orbit at 35,786 km above the Earth's equator and following the direction of the Earth's rotation) satellite is fed by one or several sat-gateways which are deployed across the satellite targeted coverage (e.g., regional or even continental coverage). It may be assumed that UEs in a cell are served by only one sat-gateway.

In one example, a non-GEO satellite is served successively by one or several sat-gateways at a time. The system ensures service and feeder link continuity between the successive serving sat-gateways with sufficient time duration to proceed with mobility anchoring and hand-over. A LEO (Low Earth Orbit: orbit around the Earth with an altitude between 300 km, and 1500 km) satellite can be one example.

In one example, a feeder link or radio link between a sat-gateway and the satellite (or UAS platform) is provided.

In one example, a service link or radio link between the user equipment and the satellite (or UAS platform) is provided.

In one example, a satellite (or UAS platform) may implement either a transparent or a regenerative (with on board processing) payload. The satellite (or UAS platform) generate beams typically generate several beams over a given service area bounded by a field of view. The footprints of the beams are typically of elliptic shape. The field of view of a satellites (or UAS platforms) depends on the on-board antenna diagram and min elevation angle.

In one example, a transparent payload is provided: radio frequency filtering, frequency conversion and amplification. Hence, the waveform signal repeated by the payload is un-changed.

In one example, a regenerative payload is provided: radio frequency filtering, frequency conversion and amplification as well as demodulation/decoding, switch and/or routing, coding/modulation. This is effectively equivalent to having all or part of base station functions (e.g., gNB) on board the satellite (or UAS platform).

In one example, inter-satellite links (ISL) is optionally provided in case of a constellation of satellites. This will require regenerative payloads on board the satellites. ISL may operate in RF frequency or optical bands.

In one example, a UE is served by the satellite (or UAS platform) within the targeted service area.

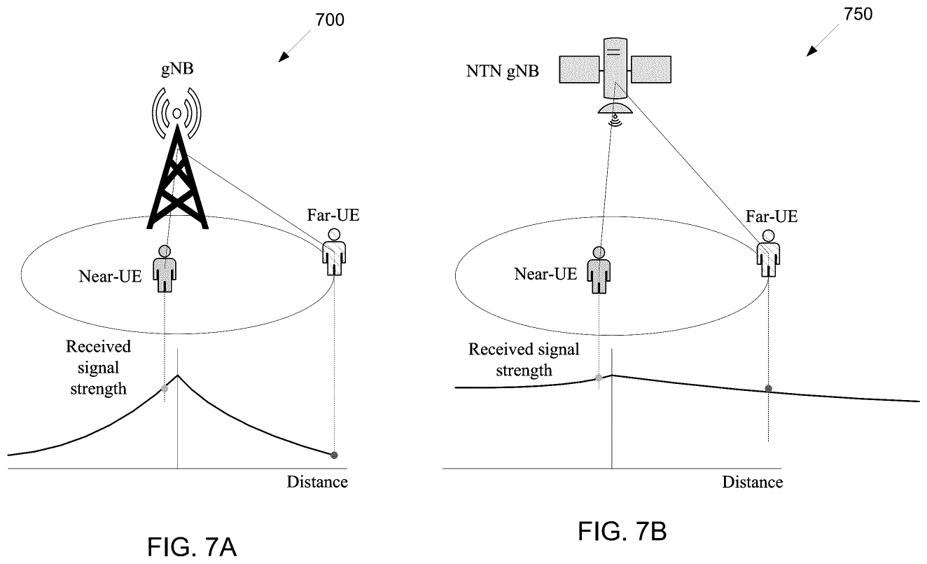

FIGS. 7A and 7B illustrate examples of bear-far effect 700 and 750 according to embodiments of the present disclosure. An embodiment of the bear-far effect 700 and 750 shown in FIGS. 7A and 7B are for illustration only.

In a TN, a UE can determine that the UE is near a cell edge due to a clear difference in RSRP as compared to a cell center. Such an effect may not be as pronounced in non-terrestrial deployments, resulting in a small difference in signal strength between two beams in a region of overlap (see FIGS. 7A and 7B).

As the Rel-15 handover mechanism is based on measurement events (e.g., A3), the UE may thus have difficulty distinguishing the better cell. To avoid an overall reduction in HO robustness due to the UE ping-ponging between cells, this challenge may be addressed with high priority for both GEO and LEO scenarios.

An NTN cell supports much wider coverage compared to a TN cell. For example, a GEO cell can support a coverage that has a radius 500 km and a LEO cell can support a coverage that has a radius 100 km. In 3GPP Release-17 (Rel-17), the basic features of NTN are supported and further enhanced features are to be considered in Rel-18. One of features is to support cell reselection enhancements for RRC idle/inactive UEs to reduce UE power consumption between NTN and TN. This embodiment provides an efficient measurement mechanism for TN neighboring cells with the reduced power consumption while the UE is in NTN serving cell.

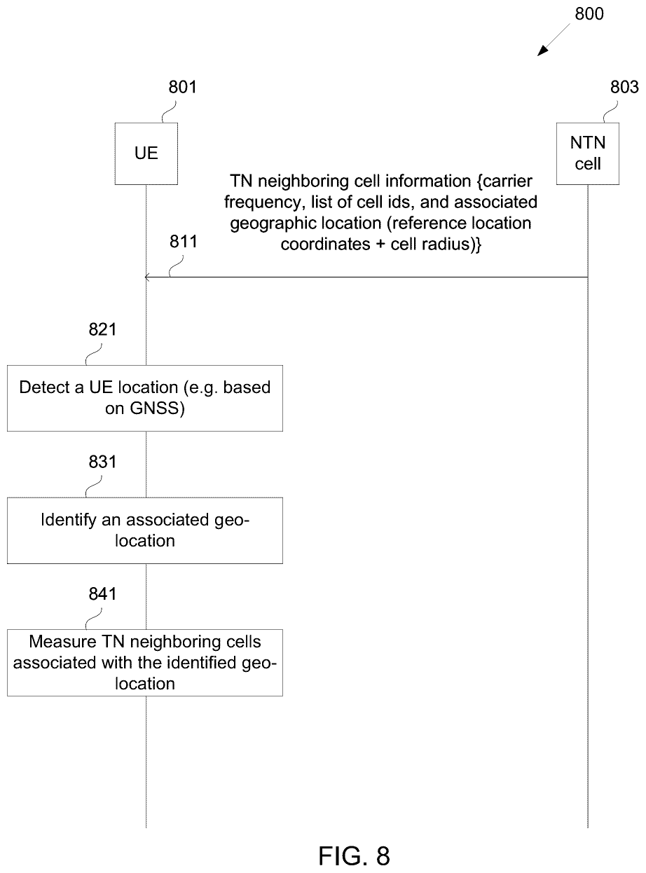

FIG. 8 illustrates signaling flows 800 between a UE and NTN according to embodiments of the present disclosure. The signaling flows 800 as may be performed by a UE (e.g., 111-116 as illustrated in FIG. 1) and an NTN network (e.g., 104 as illustrated in FIG. 1). An embodiment of the signaling flows 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

FIG. 8 illustrates an example of overall signaling flows for the embodiment. 801 indicates a UE that supports both NTN and TN and is in an RRC idle or an inactive state. 803 indicates 801 UE's serving cell that is an NTN cell. The gNB that controls 803 NTN cell transmits TN neighboring cell information in the NTN cell by either a system information block or a UE dedicated RRC message (811).

The TN neighboring cell information includes neighboring carrier frequency information, a list of neighboring cell identifiers (IDs), and associated geographic location information. The neighboring carrier frequency information is provided by absolute radio frequency channel number (ARFCN) information, which is defined in 3GPP standard specification. The neighboring cell ID is a physical cell ID of the neighboring cell. Associated geographic location information can be configured by reference location coordinates and a cell radius. Only the neighboring carrier frequency information can be included or both neighboring carrier frequency information and list of neighboring cell identifiers can be included.

For example, it may be assumed that TN neighboring cells with a physical cell id#0 to #7 (i.e., cells with a physical cell id#0, #1, #2, #3, #4, #5, #6, and #7) on carrier frequency#1 are associated with a geo-reference location coordinates {X1, Y1} or {X1, Y1, Z1} and a cell radius D1, and TN neighboring cells with a physical cell id#8 to #15 (i.e., cells with a physical cell id#8, #9, #10, #11, #12, #13, #14, and #15) on carrier frequency#2 are associated with a geo-reference location coordinates {X2, Y2} or {X2, Y2, Z2} and a cell radius D2. Note X1 and X2 can be latitude information, Y1 and Y2 can be longitude information, and Z1 and Z2 can be altitude information.

Details of location coordinates are specified in 3GPP standard specification. In another example, a cell radius D1 and D2 can be a common value. Once the UE is configured with the TN neighboring cells provided in 811, the UE first detects/identifies a current location of the UE (e.g., based on GNSS positioning mechanism) and derives current location coordinates of the UE (821).

It may be assumed that the UE's current location coordinates is {X#UE, Y#UE} or {X#UE, Y#UE, Z#UE}. Then the UE selects/identifies which associated geo-location that configured in 811 is the one that the UE location coordinates belongs to (831).

For example, if {X#UE, Y#UE} or {X#UE, Y#UE, Z#UE} is located within the range between {X1, Y1} and {X1+D1, Y1+D1} (or between {X1, Y1, Z1} and {X1+D1, Y1+D1, Z1+D1}), the UE selects/identifies the first associated geo-location in the given example. If {X#UE, Y#UE} or {X#UE, Y#UE, Z#UE} is located within the range between {X2, Y2} and {X2+D2, Y2+D2} (or between {X2, Y2, Z2} and {X2+D2, Y2+D2, Z2+D2}), the UE selects/identifies the second associated geo-location in the given example.

It may be assumed that the UE selects/identifies only the first associated geo-location as the one the UE location coordinates belongs to. Then the UE measures only TN neighboring cells associated with the selected/identified geo-location from 831 (841). In the given example, the UE selected only the first associated geo-location so the UE measures only TN neighboring cells with a physical cell id#0 to #7 on carrier frequency#1. If the carrier frequency#1 was only configured, the UE performs measurements on TN neighboring cells with all possible physical cell IDs on the carrier frequency#1. If the UE cannot select/identify any associated geo-location in 831, the UE measures all configured TN neighboring cells (when white neighboring cell list is configured), as an alternative operation, the UE detects and measure all possible TN neighboring cells (when white neighboring cell list is not configured), or as another alternative operation, the UE skips measurements on TN neighboring cells.

Note in the figure the associated geo-location is defined by using location coordinates, but as alternative example it can be defined by using round trip time (RTT) threshold (either RTT threshold alone or combination of location coordinates and RTT threshold). In this case, the UE measures the current RTT (based on derived UE location coordinates (e.g., from GNSS) and the satellite location/ephemeris information (e.g., from system information)) and compares the information with the configured RTT threshold and determine the associated geo-location the UE belongs to. Also note in the figure TN neighboring cells are assumed, but as alternative example, the embodiment can be also applied to NTN neighboring cells.

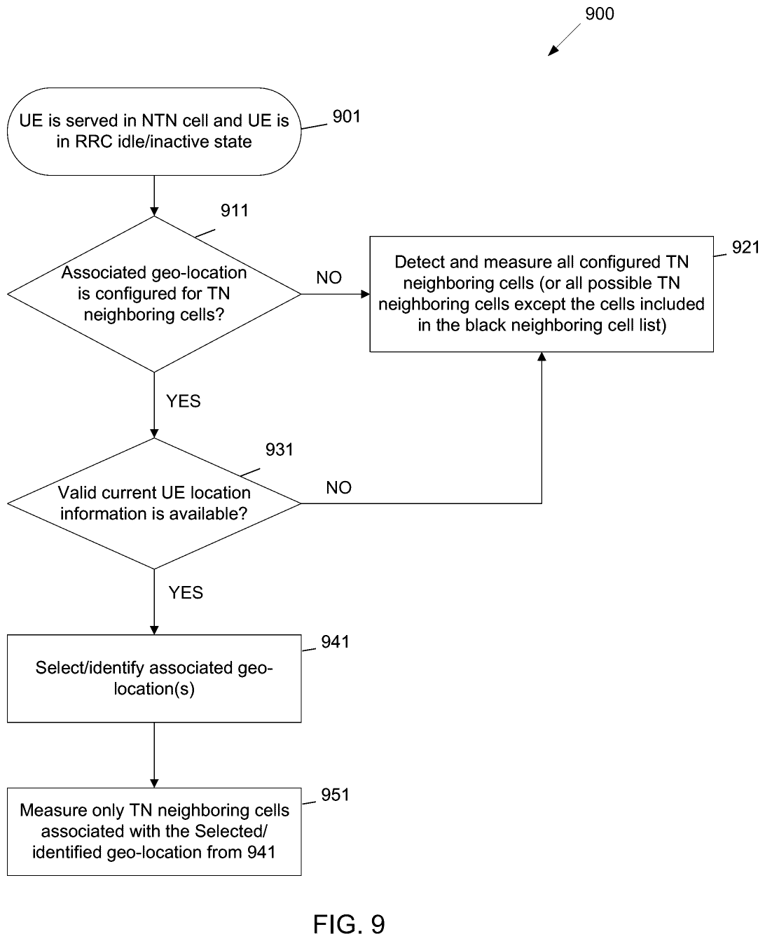

FIG. 9 illustrates a flowchart of UE method 900 according to embodiments of the present disclosure. The method 900 as may be performed by a UE (e.g., 111-116 as illustrated in FIG. 1). An embodiment of the method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

FIG. 9 illustrates an example of UE procedures according to the example in FIG. 8. 901 indicates that the UE is served in an NTN cell and the UE is in an RRC idle or an inactive state. The UE checks whether associated geo-location(s) is/are configured for TN neighboring cells to be measured (911). If associated geo-location is/are not configured for the TN neighboring cells, the UE detects and measures all configured TN neighboring cells (when white neighboring cell list is configured in system information block) or as alternative the UE detects and measure all possible TN neighboring cells except the neighboring cells included in the black neighboring cell list (when white neighboring cell list is not configured in system information block) (921).

If associated geo-location is/are configured for the TN neighboring cells, the UE checks if the UE has valid current UE location information (931). If the UE does not have valid current UE location information, the UE detects and measures all configured TN neighboring cells (when white neighboring cell list is configured in system information block) or as alternative the UE detects and measure all possible TN neighboring cells except the neighboring cells included in the black neighboring cell list (when white neighboring cell list is not configured in system information block) (921).

If the UE has valid current UE location information, the UE derives the UE location coordinates and selects/identifies (an) associated geo-location(s) that the UE location coordinates belongs to (941). Note the example is already described in FIG. 8. Once the UE selected/identified (an) associated geo-location(s), the UE measures only TN neighboring cells associated with the selected/identified geo-location from 941 (951).

Note in the figure the associated geo-location is defined by using location coordinates, but as alternative example it can be defined by using RTT threshold (either RTT threshold alone or combination of location coordinates and RTT threshold). In this case, the UE measures the current RTT (based on derived UE location coordinates (e.g., from GNSS) and the satellite location/ephemeris information (e.g., from system information)) and compares the information with the configured RTT threshold and determine the associated geo-location the UE belongs to. Also note in the figure TN neighboring cells are assumed, but as alternative example, the embodiment can be also applied to NTN neighboring cells.

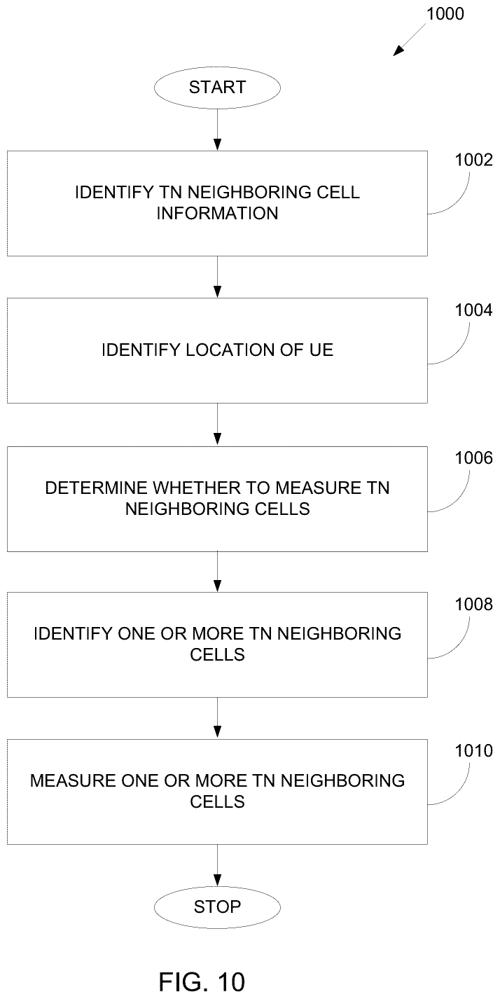

FIG. 10 illustrate a flowchart of method 1000 for mobility support between an NTN and a TN according to embodiments of the present disclosure. The method 1000 as may be performed by a UE (e.g., 111-116 as illustrated in FIG. 1). An embodiment of the method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, the method 1000 begins at step 1002. In step 1002, a UE identifies TN neighboring cell information received from an NTN, wherein the TN neighboring cell information includes at least TN neighboring cell geographical area.

In such embodiments, the TN neighboring cell geographical area includes reference location coordinates of the TN neighboring cell and a radius from the reference location coordinates of the TN neighboring cell.

In step 1004, the UE identifies a location of the UE.

In step 1006, the UE determines, based on the location of the UE and the TN neighboring cell information, whether to measure TN neighboring cells.

In step 1008, the UE identifies, based on a determination that TN neighboring cells are to be measured, one or more TN neighboring cells among the TN neighboring cells.

In step 1010, the UE measures the one or more TN neighboring cells for a cell reselection operation.

In one embodiment, the UE receives the TN neighboring cell information via an SIB or a UE dedicated RRC message, wherein the TN neighboring cell information further includes one or more TN neighboring cell frequencies or one or more cell IDs.

In such embodiments, the one or more TN neighboring cell frequencies are identified based on an ARFCN.

In such embodiments, the one or more cell IDs are identified based on a PCID.

In one embodiment, the UE determines whether the location of the UE is within the TN neighboring cell geographical area, wherein a determination that the TN neighboring cells are to be measured is based on the location of the UE being within the radius from the reference location coordinates of the TN neighboring cell.

In one embodiment, the UE identifies a TN neighboring cell frequency corresponding to the TN neighboring cell geographical area and measures TN neighboring cells associated with the TN neighboring cell frequency.

In one embodiment, when the TN neighboring cell information includes one or more cell IDs, the UE measures only the one or more cell IDs included in the TN neighboring cell information.

In one embodiment, the UE skips a TN neighboring cell measurement operation when the location of the UE is not within the TN neighboring cell geographical area.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), the UE comprising:
a transceiver; and
a processor operably coupled to the transceiver, the processor configured to:
identify terrestrial network (TN) neighboring cell information received from a non-terrestrial network (NTN), wherein the TN neighboring cell information includes at least TN neighboring cell geographical area,
identify a location of the UE,
determine, based on the location of the UE and the TN neighboring cell information, whether to measure TN neighboring cells,
identify, based on a determination that TN neighboring cells are to be measured, one or more TN neighboring cells among the TN neighboring cells, and
measure the one or more TN neighboring cells for a cell reselection operation.

2. The UE of claim 1, wherein:
the TN neighboring cell information further includes one or more TN neighboring cell frequencies or one or more cell identifications (IDs); and
the transceiver is configured to receive the TN neighboring cell information via a system information block (SIB) or a UE dedicated radio resource control (RRC) message.

3. The UE of claim 2, wherein the one or more TN neighboring cell frequencies are identified based on an absolute radio frequency channel number (ARFCN).

4. The UE of claim 2, wherein the one or more cell IDs are identified based on a physical cell ID (PCID).

5. The UE of claim 1, wherein the TN neighboring cell geographical area includes reference location coordinates of the TN neighboring cell and a radius from the reference location coordinates of the TN neighboring cell.

6. The UE of claim 5, wherein:
the processor is further configured to determine whether the location of the UE is within the TN neighboring cell geographical area; and
a determination that the TN neighboring cells are to be measured is based on the location of the UE being within the radius from the reference location coordinates of the TN neighboring cell.

7. The UE of claim 6, wherein the processor is further configured to:
identify a TN neighboring cell frequency corresponding to the TN neighboring cell geographical area; and
measure TN neighboring cells associated with the TN neighboring cell frequency.

8. The UE of claim 7, wherein, when the TN neighboring cell information includes one or more cell identifications (IDs), the processor is further configured to measure only the one or more cell IDs included in the TN neighboring cell information.

9. The UE of claim 7, wherein the processor is further configured to skip a TN neighboring cell measurement operation when the location of the UE is not within the TN neighboring cell geographical area.

10. A method of a user equipment (UE), the method comprising:
identifying terrestrial network (TN) neighboring cell information received from a non-terrestrial network (NTN), wherein the TN neighboring cell information includes at least TN neighboring cell geographical area;
identifying a location of the UE;
determining, based on the location of the UE and the TN neighboring cell information, whether to measure TN neighboring cells;
identifying, based on a determination that TN neighboring cells are to be measured, one or more TN neighboring cells among the TN neighboring cells; and
measuring the one or more TN neighboring cells for a cell reselection operation.

11. The method of claim 10, further comprising receiving the TN neighboring cell information via a system information block (SIB) or a UE dedicated radio resource control (RRC) message, wherein the TN neighboring cell information further includes one or more TN neighboring cell frequencies or one or more cell identifications (IDs).

12. The method of claim 11, wherein the one or more TN neighboring cell frequencies are identified based on an absolute radio frequency channel number (ARFCN).

13. The method of claim 11, wherein the one or more cell IDs are identified based on a physical cell ID (PCID).

14. The method of claim 10, wherein the TN neighboring cell geographical area includes reference location coordinates of the TN neighboring cell and a radius from the reference location coordinates of the TN neighboring cell.

15. The method of claim 14, further comprising determining whether the location of the UE is within the TN neighboring cell geographical area,
wherein a determination that the TN neighboring cells are to be measured is based on the location of the UE being within the radius from the reference location coordinates of the TN neighboring cell.

16. The method of claim 15, further comprising:
identifying a TN neighboring cell frequency corresponding to the TN neighboring cell geographical area; and
measuring TN neighboring cells associated with the TN neighboring cell frequency.

17. The method of claim 16, wherein, when the TN neighboring cell information includes one or more cell identifications (IDs), further comprising measuring only the one or more cell IDs included in the TN neighboring cell information.

18. The method of claim 16, further comprising skipping a TN neighboring cell measurement operation when the location of the UE is not within the TN neighboring cell geographical area.
